(19) United States
(12) Patent Application Publication
(10) Pub. No.: US 2006/0204115 A1
(43) Pub. Date: Sep. 14, 2006

(54) Video encoding

(76) Inventor: Dzevdet Burazerovic, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/547,322

(22) PCT Filed: Feb. 25, 2004
(86) PCT No.: PCT/IB04/50144

§ 371 Date: Aug. 30, 2005

(30) Foreign Application Priority Data
Mar. 3, 2003 (EP) 03100521.8

(51) Int. Cl. G06K 9/36; H04N 11/04; H04K 1/06

(52) U.S. Cl. 382/239; 375/240.01; 380/37

(57) ABSTRACT

The invention relates to a video encoding apparatus (100) comprising a video analysis processor (101) and a video encoder (103). The video analysis processor (101) comprises a segmentation processor (109) which divides a picture into a plurality of picture regions. A picture characteristic processor (111) determines picture characteristic, such as a texture level, for one of the regions, and in response a video encoding selector (113) selects a video encoding parameter for that region. The video encoding parameter is fed to the video encoder (103) wherein a video encode processor (I 19) encodes the picture using the video encoding parameter determined by the external analysis by the video analysis processor (101). The encoded picture is fed back to the video analysis processor (101) and the process is iterated until a desired encoding performance is achieved. The apparatus is particularly suitable for H.264 encoding and allows for improved performance from a selection of encoding parameters based on an external analysis.

### FIELD OF THE INVENTION

The invention relates to a video encoding apparatus and method of video encoding therefore and in particular to selection of video encoding parameters for video encoding.

### BACKGROUND OF THE INVENTION

In recent years, the use of digital storage and distribution of video signals have become increasingly prevalent. In order to reduce the bandwidth required to transmit digital video signals, it is well known to use efficient digital video encoding comprising video data compression whereby the data rate of a digital video signal may be substantially reduced.

In order to ensure interoperability, video encoding standards have played a key role in facilitating the adoption of digital video in many professional—and consumer applications. Most influential standards are traditionally developed by either the International Telecommunications Union (ITU-T) or the MPEG (Motion Pictures Experts Group) committee of the ISO/IEC (the International Organization for Standardization/the International Electrotechnical Committee. The ITU-T standards, known as recommendations, are typically aimed at real-time communications (e.g. videoconferencing), while most MPEG standards are optimized for storage (e.g. for Digital Versatile Disc (DVD)) and broadcast (e.g. for Digital Video Broadcast (DVB) standard).

Currently, one of the most widely used video compression techniques is known as the MPEG-2 (Motion Picture Expert Group) standard. MPEG-2 is a block based compression scheme wherein a frame is divided into a plurality of blocks each comprising eight vertical and eight horizontal pixels. For compression of luminance data, each block is individually compressed using a Discrete Cosine Transform (DCT) followed by quantization which reduces a significant number of the transformed data values to zero. For compression of chrominance data, the amount of chrominance data is usually first reduced by down-sampling, such that for each four luminance blocks two chrominance blocks are obtained (4:2:0 format), that are similarly compressed using the DCT and quantization. Frames based only on intra-frame compression are known as Intra Frames (I-Frames).

In addition to intra-frame compression, MPEG-2 uses inter-frame compression to further reduce the data rate. Inter-frame compression includes generation of predicted frames (P-frames) based on previous I-frames. In addition, I and P frames are typically interposed by Bidirectional predicted frames (B-frames), wherein compression is achieved by only transmitting the differences between the B-frame and surrounding I- and P-frames. In addition, MPEG-2 uses motion estimation wherein the image of macroblocks of one frame found in subsequent frames at different positions are communicated simply by use of a motion vector.

As a result of these compression techniques, video signals of standard TV studio broadcast quality level can be transmitted at data rates of around 2-4 Mbps.

Recently, a new ITU-T standard, known as H.26L, has emerged. H.26L is becoming broadly recognized for its superior coding efficiency in comparison with the existing standards such as MPEG-2. Although the gain of H.26L generally decreases in proportion to the picture size, the potential for its deployment in a broad range of applications is undoubted. This potential has been recognized through formation of the Joint Video Team (JVT) forum, which is responsible for finalizing H.26L as a new joint ITU-T/MPEG standard. The new standard is known as H.264 or MPEG-4 AVC (Advanced Video Coding). Furthermore, H.264-based solutions are being considered in other standardization bodies, such as the DVB and DVD Forums.

The H.264 standard employs the same principles of block-based motion-compensated hybrid transform coding that are known from the established standards such as MPEG-2. The H.264 syntax is, therefore, organized as the usual hierarchy of headers, such as picture-, slice- and macro-block headers, and data, such as motion-vectors, block-transform coefficients, quantizer scale, etc. However, the H.264 standard separates the Video Coding Layer (VCL), which represents the content of the video data, and the Network Adaptation Layer (NAL), which formats data and provides header information.

Furthermore, H264 allows for a much increased choice of encoding parameters. For example, it allows for a more elaborate partitioning and manipulation of 16×16 macro-blocks whereby e.g. motion compensation process can be performed on segmentations of a macro-block as small as 4×4 in size. Also, the selection process for motion compensated prediction of a sample block may involve a number of stored previously-decoded pictures, instead of only the adjacent pictures. Even with intra coding within a single frame, it is possible to form a prediction of a block using previously-decoded samples from the same frame. Also, the resulting prediction error following motion compensation may be transformed and quantized based on a 4×4 block size, instead of the traditional 8×8 size.

The H.264 standard may be considered a superset of the MPEG-2 video encoding syntax in that it uses the same global structuring of video data, while extending the number of possible coding decisions and parameters. A consequence of having a variety of coding decisions is that a good trade-off between the bit rate and picture quality may be achieved. However, although it is commonly acknowledged that while the H.264 standard may significantly reduce typical artefacts of block-based coding, it can also accentuate other artefacts.

The fact that H.264 allows for an increased number of possible values for various coding parameters thus results in an increased potential for improving the encoding process but also results in increased sensitivity to the choice of video encoding parameters. Similarly to other standards, H.264 does not specify a normative procedure for selecting video encoding parameters, but describes through a reference implementation, a number of criteria that may be used to select video encoding parameters such as to achieve a suitable trade-off between coding efficiency, video quality and practicality of implementation.

However, the described criteria may not always result in an optimal or suitable selection of coding parameters. For example, the criteria may not result in selection of video encoding parameters optimal or desirable for the characteristics of the video signal or the criteria may be based on attaining characteristics of the encoded signal which are not appropriate for the current application.

Accordingly, an improved system for video encoding would be advantageous and in particular an improved video encoding system exploiting the possibilities of emerging standards, such as H.264, to improve video encoding is advantageous. Specifically, a video encoding system allowing for improved selection of encoding parameters is desirable.

### SUMMARY OF THE INVENTION

Accordingly, the invention seeks to mitigate, alleviate or eliminate one or more of the above mentioned disadvantages singly or in any combination.

According to a first aspect of the invention, there is provided a video encoding apparatus comprising: a video analysis processor comprising means for receiving a picture for encoding, means for dividing the picture into a plurality of picture regions; means for determining a picture characteristic for at least one picture region of the plurality of picture regions, and means for selecting a video encoding parameter for the at least one picture region in response to the picture characteristic; and a video encoder comprising: means for receiving the picture for encoding, means for receiving the video encoding parameter from the video analysis processor, and means for encoding the picture using the video encoding parameter for the at least one picture region.

The invention allows for one or more video encoding parameters for a video encoder to be selected in response to an external picture and video analysis. The selected video encoding parameter may be used for one or more pictures. The external analysis allows the picture to be divided into different picture regions in accordance with any suitable criteria or algorithm and may be independent of any process performed in the video encoder. This allows for an efficient resource use and processing partition and enables the video encoding parameter to be determined in response to other parameters than only a local spatial pixel analysis. This allows for improved selection the video encoding parameter, and thus for a reduced encoding data rate and/or improved encoded video quality.

Furthermore, the invention allows for the external video analysis performed by the video analysis processor to use different criteria for video encoding parameter selection in different regions. The criterion for selection of video encoding parameters in the at least one picture region may be selected in response to characteristics of that region. This allows for different trade-offs between for example bit rate and video quality to be used depending on the characteristics of the individual region. For example, video encoding parameters for a moving object may be selected in accordance with a given quality versus data rate trade-off, whereas a different quality versus data rate trade-off may be used for background objects. Hence, the invention allows for different relative video quality levels in different regions. This may be useful for different applications wherein the relative perceived importance of different objects may vary. The picture may itself be an encoded signal.

The invention allows for improved video encoding and may specifically allow for reduced encoded data rate, improved video quality and/or an improved, varying and/or flexible trade-off between characteristics of the encoded video signal. The invention allows for a low complexity and/or flexible video encoding apparatus suitable for implementation.

According to a feature of the invention, the means for dividing the picture is operable to determine the plurality of picture regions by segmentation of the picture. This provides a suitable approach for dividing a picture into picture regions in each of which the same video encoding parameter may advantageously be used. The picture may be segmented into different regions in accordance with any suitable algorithm or criterion. The picture segmentation may be performed by either recursively splitting the whole picture or by merging groups of pixels in the picture, based on similarity of features that can be derived from pixels values and/or from mathematical computations on these values. This makes it possible to isolate regions that have certain color, spectral characteristics, etc. In a sequence of pictures, it is possible to perform segmentation of each picture separately, or to project and refine the results of segmentation of one picture to the consecutive pictures, using any matching criterion or algorithm, e.g. such as used for motion compensation.

According to a different feature of the invention, the segmentation of the picture comprises tracking an object between frames of a video signal. This may facilitate the division into picture regions and/or increase the consistence and correlation between pictures. For example, the same video encoding parameters may be used for the same object in consecutive pictures thereby allowing for consistency in the video encoding of that object and thereby a reduced noise of the encoded picture.

According to a different feature of the invention, the means for dividing the picture is operable to divide the plurality of picture regions in response to picture properties not comprised in the picture characteristic. A flexible selection of regions may thus be made independently of the criterion for selecting the video encoding parameter. This allows for an improved video encoding and in particular for an improved video quality and/or reduced data rate of the encoded signal. For example, the picture may be divided into a plurality regions in response to a movement characteristic of different objects, such that, for instance, a plurality of moving objects and background objects are determined. However, the video encoding parameter of each region or object may be selected in response to other characteristics of the regions or blocks and the selection criteria may be different for different blocks. E.g., the video encoding parameters may be selected to achieve a first quality level for moving objects and a second higher quality level for background objects and the specific encoding parameters may be selected to achieve the appropriate quality level for the given picture characteristics (such as the level of high frequency content) of the individual objects.

According to a different feature of the invention, the means for dividing the picture is operable to determine the at least one picture region as a picture region having picture characteristics resulting in a high sensitivity to video encoding parameters. This allows for sensitive regions to be determined in accordance with any suitable criterion or algorithm and for a relatively higher quality requirement being used for selecting video encoding parameters for these regions. This allows for an improved video quality of the encoded video signal.

According to a different feature of the invention, the means for dividing the picture is operable to divide the picture into a plurality of segments in response to a segmentation criterion and to determine the at least first picture region by grouping a plurality of segments. This allows for an efficient and low complexity way of determining picture regions by grouping individual segments. A picture region may comprise a plurality of separate regions in the picture.

According to a different feature of the invention, the division into the plurality of segments is in response to a segmentation criterion and the grouping is in response to video encoding characteristics of the plurality of segments. The segmentation criterion may specifically be suitable for determining regions which may advantageously be encoded with the same video encoding parameters. For example, a picture region may be formed by grouping all segments corresponding to moving objects in a picture. This allows for an efficient and low complexity approach to selecting video encoding parameters for picture regions and allows for an efficient interface between the video encoder and the video analysis processor. The segmentation criterion may for example be related to picture characteristics such as a colour characteristic, a texturing characteristic and/or a flatness or uniformity characteristic.

According to a different feature of the invention, the picture characteristics comprise a texture characteristic. This allows for the video encoding parameter to be selected to provide a suitable encoding for the given texture characteristic. Specifically, it allows for the video encoding parameters to be adapted to texture characteristics of areas of high uniformity whereby the partial smearing of texture or “plastification” typically encountered in known encoders, such as H.264 or MPEG-4 AVC video encoders, may be reduced.

According to a different feature of the invention, the video encoding apparatus further comprises means for coupling the encoded picture from the video encoder to the video analysis processor and the video analysis processor is operable to generate the picture characteristic in response to the encoded picture. This allows for improved selection of the video encoding parameter and thus improved video quality and/or reduced data rate of the video encoding. The picture characteristic may be determined in response to a characteristic of the encoded picture and especially in response to a characteristic associated with the video encoding. For example, video encoding artefacts and/or errors may be determined and used in determining the picture characteristic. For example, the picture characteristic may be related to a quality level of the encoded signal in a region and may result in modification of the video encoding parameter to more closely attain the desired quality level. Thus an iterative video encoding and selection of the video encoding parameter may be implemented. The iterations may be repeated one or more times for example until a given encoded video quality level is achieved.

According to a different feature of the invention, the video encoding apparatus is operable to encode the picture by iteratively selecting a video encoding parameter for the at least one picture and encoding the picture using the video encoding parameter for the at least one picture region. This allows for improved video quality and/or reduced data rate to be achieved by the video encoding. An iterative video encoding and selection of the video encoding parameter may be implemented. The iterations may be repeated one or more times for example until a given encoded video quality level is achieved.

According to a different feature of the invention, the video encoding parameter comprises a quantisation parameter, an encoding block type parameter, an inter frame prediction mode parameter, a reference picture selection parameter and/or a de-blocking filtering parameter. These parameters are particularly suited for adapting the video encoding to the characteristics of the picture region.

According to a different feature of the invention, the video encoder is operable to encode the video signal in accordance with the H264 (or H.26L or MPEG-4 AVC) standard. Thus the invention enables an improved H.264 (or H.26L or MPEG-4 AVC) video encoder apparatus.

According to a second aspect of the invention, there is provided a method of video encoding for a video encoding apparatus having a video analysis processor and a video encoder comprising the steps of: in the video analysis processor: receiving a picture for encoding, dividing the picture into a plurality of picture regions; determining a picture characteristic for at least one picture region of the plurality of picture regions; selecting a video encoding parameter for the picture region in response to the picture characteristic of the picture region, and feeding the video encoding parameter to the video encoder; and in the video encoder: receiving the picture for encoding, receiving the video encoding parameter from the video analysis processor, and encoding the picture using the video encoding parameters for each picture region.

According to a feature of the invention, the method further comprises the steps of: in the video analysis processor: receiving the encoded picture from the video encoder, dividing the encoded picture into a plurality of encoded picture regions; determining an encoded picture characteristic for at least one encoded picture region of the plurality of encoded picture regions; selecting a second video encoding parameter for the encoded picture region in response to the encoded picture characteristic of the encoded picture region, and feeding the second video encoding parameter to the video encoder; and in the video encoder: receiving the second video encoding parameter from the video analysis processor, and encoding the picture using the second video encoding parameters for each picture region.

This allows for improved video quality and/or reduced data rate to be achieved by the encoding of the picture. An iterative video encoding and selection of the video encoding parameters may be implemented. The iterations may be repeated one or more times for example until a given encoded video quality level is achieved.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 is an illustration of a block diagram of a video encoding apparatus in accordance with an embodiment of the invention; and

FIG. 2 is an illustration of a method of video encoding in accordance with a preferred embodiment of the invention.

### DESCRIPTION OF PREFERRED EMBODIMENTS

The following description focuses on an embodiment of the invention applicable to video encoding in accordance with the H.26L, H.264 or MPEG-4 AVC video encoding standards. However, it will be appreciated that the invention is not limited to this application but may be applied to many other video encoding algorithms, specifications or standards.

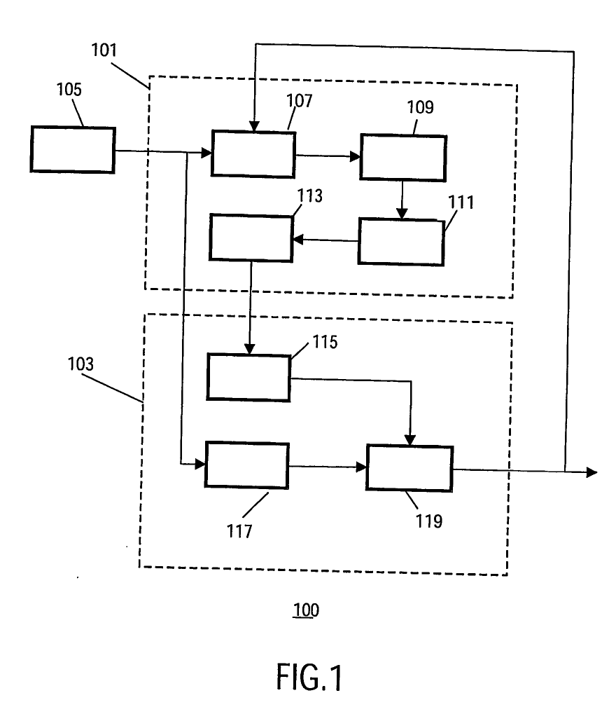

FIG. 1 is an illustration of a block diagram of a video encoding apparatus 100 in accordance with an embodiment of the invention.

The video encoding apparatus 100 comprises a video analysis processor 101 and a video encoder 103. The video analysis processor 101 and video encoder 103 are coupled to an external video source 105 from which a video signal to be encoded is received. The video analysis processor 101 comprises a processor receiver 107 coupled to the video source 105. The processor receiver 107 receives the video signal to be encoded. The video signal comprises a plurality of pictures which are to be encoded. In the preferred embodiment, the processor receiver 107 comprises a buffer that stores a picture during the video analysis of the picture. The receiver is coupled to a segmentation processor 109 which is operable to divide the picture into a plurality of picture regions. The picture may be divided into two or more picture regions in response to any suitable algorithm or criterion and specifically the picture may be divided into two picture regions by selecting a single picture region for which a given criterion is met.

The segmentation processor 109 is coupled to a picture characteristic processor 111. The picture characteristic processor 111 is fed data related to one, more or all of the picture regions determined by the segmentation processor 109. In response, the picture characteristic processor 111 determines a picture characteristic for at least one picture region of the plurality of picture regions. The picture characteristic is in the preferred embodiment indicative of a property of the picture region that may influence the performance of a video encoding of the picture region. For example, the picture characteristic may be an indication of the spatial frequency characteristics of the image contained in the picture region. Specifically, the picture characteristic may indicate if the picture region contains a uniform image having a relatively low high frequency content or contains an image having a relatively high content of high frequency components.

The picture characteristic processor 111 is coupled to a video encoding selector 113 which is operable to select a video encoding parameter for the at least one picture region in response to the picture characteristic. The video encoding selector 113 preferably selects a video encoding parameter which is particularly suitable for encoding of an image having the characteristics as are determined for the picture region. In some embodiments, the video encoding parameter may comprise a group of different video encoding parameters and/or may comprise a list of allowable values for the video encoding parameter. Hence, in some cases, a specific parameter value may be selected for one or more video encoding parameter(s) whereas in other embodiment a video parameter having a range of allowable values may be selected. Accordingly, the video encoding parameter provides a constraint or restriction for the choice of encoding parameters for the consequent video encoding. Thus, in the preferred embodiment, the video encoding selector 113 controls or influences the operation of the video encoder 103.

The video encoder 103 comprises an interface 115 for receiving the video encoding parameter from the video analysis processor 101. The interface 115 is accordingly coupled to the video encoding selector 113. The protocol and interface for the exchange of the information between the video analysis processor 101 and the video encoder 103 depends on the application and may be selected by the person skilled in the art to suit the specific embodiment.

The video encoder 103 further comprises an encoder receiver 117 coupled to the video source 105 and operable to receive the picture for encoding therefrom. The encoder receiver 117 and interface 115 are coupled to a video encode processor 119 which is operable to encode the picture using the video encoding parameter for the at least one picture region. Thus the video encode processor 119 encodes the picture received from the video source using the video encoding parameter determined by the video analysis processor 101. Accordingly, the video encoding may be optimised based on the external analysis of the video analysis processor 101, which may be independent of the processing of the video encoder. In the preferred embodiment, the video encode processor 119 is an H.264 video encoder.

In the preferred embodiment, the encoded video signal from the video encode processor 119 is coupled back to the video analysis processor 101. Specifically the output of the video encode processor 119 may be coupled to the processor receiver 107 as shown in FIG. 1. This feedback coupling allows the video analysis processor 101 to determine the picture characteristic and thus the video encoding parameter based on the encoded signal. The process of selecting a video encoding parameter and encoding the picture may thus be iterated. This allows for an improved quality and/or efficiency of the video encoding. The picture characteristic and video encoding parameter may be different in different iterations.

Hence in accordance with the preferred embodiment, the adaptation of H.264 coding parameters is not limited to spatially local pixel analysis but may also involve external methods of picture and video analysis, such as segmentation. Hence, a higher-level data classification may be used, and specifically the higher-level classification and iterative approach may facilitate identification of picture regions where encoding artefacts may appear or be particularly disturbing. Additionally or alternatively, it may facilitate encoding parameter adaptation in order to reduce these artefacts.

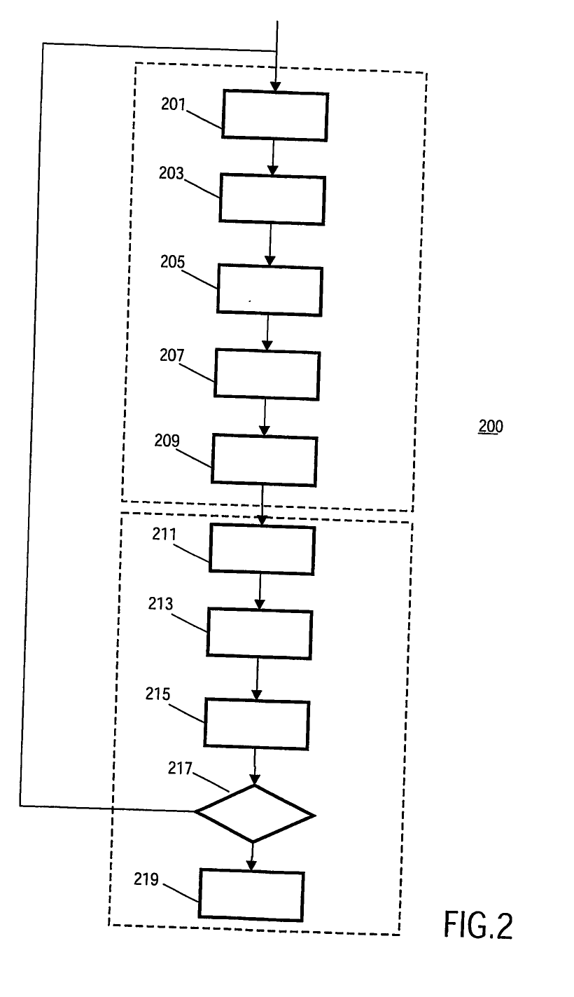

FIG. 2 is an illustration of a method of video encoding in accordance with a preferred embodiment of the invention. The method is applicable to, and will be described with reference to, the video encoding apparatus of FIG. 1. In the described embodiment, steps 201 to 209 are performed in the video analysis processor 101 and steps 211 to 219 are performed in the video encoder 103.

In step 201, the processor receiver 107 receives a picture for encoding from the external video source 105.

Step 201 is followed by step 203 wherein the picture is fed to the segmentation processor 109 and the picture is divided into a plurality of picture regions. In a simple embodiment, a single picture region may be selected in accordance with a criterion and the picture is divided into just two picture regions consisting in the selected picture region and a picture region comprising the remainder of the picture. However, in the preferred embodiment the picture is divided into several picture regions.

In the preferred embodiment, the picture is divided into picture regions by segmentation of the picture. In the preferred embodiment picture segmentation comprises the process of a spatial grouping of pixels based on a common property (e.g. colour). There exist several approaches to picture- and video segmentation, and the effectiveness of each will generally depend on the application. It will be appreciated that any known method or algorithm for segmentation of a picture may be used without detracting from the invention. An introduction to picture or video segmentation may be found in E. Steinbach, P. Eisert, B. Girod, “Motion-based Analysis and Segmentation of Image Sequences using 3-D Scene Models.” Signal Processing: Special Issue: Video Sequence Segmentation for Content-based Processing and Manipulation, vol. 66, no. 2, pp. 233-248, 1998.

The picture segmentation may be performed by either recursively splitting the whole picture or by merging groups of pixels in the picture, based on similarity of features that can be derived from pixels values and/or from mathematical computations on these values. This makes it possible to isolate regions that have certain color, spectral characteristics, etc. In a sequence of pictures, it is possible to perform segmentation of each picture separately, or to project and refine the results of segmentation of one picture to the consecutive pictures, using any matching criterion or algorithm, e.g. such as used for motion compensation.

A picture segment obtained in this way may in general include an arbitrary number of pixels, which means that the segment boundaries may have an arbitrary geometrical shape. However, for adaptation of block-based (H.264) coding parameters and decisions, each segment will ultimately include a plurality of pixel blocks or one of more picture slices. In this case, the necessary re-shaping of the irregular segment boundaries can be achieved by re-assigning pixels among neighboring segments, based on any suitable algorithm or criterion. For example, a majority criterion can be used, meaning that a certain block will be included in a certain segment if more than 50% of its area overlaps with the initial segment. Alternatively, the process of segmentation may itself be restricted such to operate using block-shaped groups of pixels from the start.

In the preferred embodiment, the segmentation includes detecting an object in response to a common characteristic, such as a colour or a level of uniformity (or flatness), and consequently tracking this object from one picture to the next. This provides for simplified segmentation and facilitates identification of suitable regions for being encoded with identical video encoding parameters. Furthermore, in some embodiments different parameters may be used for the segmentation than for the picture characteristic used to determine the video encoding parameter for the region. For example, the segmentation may group together picture areas having a similar colour content. Hence, if for example the video signal is of a football match, the segmentation may comprise identifying predominantly green areas and grouping these together. However, the video encoding parameter for the resulting picture region will not be based on the predominance of the green colour but may be selected in response to the texture or detail level of these areas. This allows for areas of the picture mainly corresponding to the grass to be identified and encoded using parameters suitable for efficiently encoding high texture areas. Furthermore, e.g. the football shirts of players may be identified in one picture and tracked through motion estimation in consequent pictures. As an example, an initial picture may segmented and the obtained segments tracked across subsequent pictures, until a new picture is segmented independently again, etc. The segment tracking is preferably performed by employing known motion estimation techniques.

In the preferred embodiment, the picture regions may comprise a plurality of picture areas which are suitable for similar choices of video encoding parameters. Thus, a picture region may be formed by grouping of a plurality of segments. For example, if the video signal corresponds to a football match, all regions having a predominantly green colour may be grouped together as one picture region. As another example, all segments having a predominant colour corresponding to the colour of the shirts of one of the teams may be grouped together as one picture region.

The picture segments need not necessarily correspond to physical objects. For example, two neighbouring segments may represent different objects but may both be highly textured. In this case, both segments may be suited for the same selection of video encoding parameters. Furthermore, if an iterative approach is implemented, the segmentation may include or be exclusively based on the coding statistics available from the H.264 video encoding. For example, similarity of motion data in two different segments could be a motivation for clustering these two segments into a larger segment.

In some embodiments, the picture is divided such that one or more regions which are particularly sensitive to the choice of video encoding parameters are determined. For example, it is commonly acknowledged that while H.264 can significantly reduce some typical artefacts of MPEG-2 video encoding, it can also cause other artefacts. One such artefact is a partial removal of texture, resulting in a plastic like appearance of some picture areas. This is especially noticeable for larger picture formats, such as High Definition TV.

A possible explanation for the removal of texture, which is of a predominantly high frequency nature, is that in H.264 a 16×16 macro-block may be transformed using a 4×4 block transform. In contrast, MPEG-2 uses an 8×8 DCT transform for the same purpose. Accordingly, by using smaller transform blocks, H.264 compacts signal energy into a larger number of low frequency coefficients, leaving a smaller number of high frequency coefficients that are more susceptible to be suppressed during the consecutive video encoding (for example due to coefficient weighting or quantization). Accordingly, in one embodiment the segmentation of the picture may be such that areas with high levels of texture are identified and grouped together as a picture region. The video encoding parameters may then be selected to ensure a high quality of encoding for high texture images. Specifically, the video encoding parameter may be selected to correspond to MPEG-2 video encoding parameters as these are known to result in significantly less loss of texture information.

Step 203 is followed by step 205 wherein a picture characteristic for at least one picture region of the plurality of picture regions is determined. Any suitable picture characteristic may be used without detraction from the invention. Preferably, the picture characteristic comprises one or more characteristics that are relevant for the performance of the video encoding of the picture region. For example, the picture characteristic may be an indication of the spatial frequency distribution for the picture region. Specifically, a level of uniformity or flatness may be determined and preferably, the picture characteristic comprises a texture characteristic. The texture characteristic may be determined from a Discrete Cosine Transformation (DCT) performed on blocks in the picture region. The higher the concentration of energy in the higher frequency coefficients, the higher the texture level may be considered to be. Another picture characteristic may be a motion estimation parameter, which may be indicative of the relative speed within the picture of an object associated with the picture region.

Step 205 is followed by step 207 wherein the video encoding selector 113 selects a video encoding parameter for the picture region in response to the picture characteristic of the picture region. In the preferred embodiment, an encoding block type parameter is selected in response to the texture characteristics. Thus if the texture characteristic indicates a high level of texture, a large block size is selected, and if a low texture level is indicated, a lower block size may be selected. This provides for reduced loss of texture information and thus reduces the plastification or texture smearing effect.

The video encoding parameter may additionally or alternatively comprise other parameters, including the following:

A quantisation parameter: A quantisation parameter may be set by the video encoding selector 113. For example, a quantisation threshold below which all coefficients following an encoding DCT are set to zero may be set. A lower threshold may result in reduced bit rates but also reduced picture quality. As the video quality level of moving objects is less critical to the human perception than the video quality level of a static object, the quantisation threshold may be reduced for an increased movement indication of the picture characteristic.

An inter frame prediction mode parameter: For example, a video encoding parameter may be set to select between inter or intra frame prediction and/or a prediction block size may be set in response to the picture characteristic.

A reference picture selection parameter: For example, one or more pictures user for interpolation or motion estimation may be selected in response to the picture characteristic. Alternatively or additionally, a limit on the pictures that may be used as a reference for encoding of the current picture may be selected.

A de-blocking filtering parameter: For example the activation of a de-blocking filter and/or the strength of the filtering may be set by the video encoding selector 113.

As a specific example, a picture characteristic indicating a texture level above a given threshold may result in a video encoding parameter to be selected that comprises parameter values which are closely related to the parameters used in MPEG-2 video encoding. Thus the video encoding parameter may comprise parameter values that correspond to parameter values available for MPEG-2 encoding. For example, inter prediction may be restricted for H.264 encoding such that it uses only 8×8 blocks. The video encoding parameter may also restrict the prediction to be based on only the most recently decoded pictures. Additionally Adaptive Block Transform (ABT) filtering may be activated to ensure that the transform size matches the prediction block size [8].

This will result in a good approximation to MPEG-2 encoding, because MPEG-2 uses only the most recently decoded pictures and an 8×8 transform (DCT), whereas it performs inter prediction based on 16×16 blocks. By selection of parameters compatible with MPEG-2, the same video encoding performance as MPEG-2 can be achieved for the specific picture region. Thus, a picture region may be determined for which MPEG-2 are expected to provide a preferred performance in comparison to conventional H.264 encoding. For that specific picture region, the performance of the H.264 encoder may be controlled to use similar or identical encoding parameters to MPEG-2. In this way, the preferred performance of MPEG-2 encoding may be achieved from the H.264 encoder.

Step 207 is followed by step 209 wherein the video encoding parameter is fed to the video encoder 103 and specifically the interface 115.

Steps 211 to 219 are performed in the video encoder 103. Instep 211, the encoder receiver 117 receives the picture to be encoded from the external video source 105. FIG. 2 illustrates step 211 to follow from step 209 but typically steps 201 and 211 are executed simultaneously. Specifically, the encoder receiver 117 may comprise a buffer that stores the picture until the video analysis processor 101has determined the video encoding parameter.

In step 213, the interface 115 receives the video encoding parameter from the video encoding selector 113. Typically, steps 209 and 213 are simultaneous.

In step 215, the video encode processor 119 encodes the picture using the video encoding parameter for each picture region. The video encoding is in the preferred embodiment in accordance with the H.264 standard and the video encoder is an H.264 video encoder. However, the encoding process is controlled by the received video encoding parameter, and thus by the video analysis processor 101. Specifically, the video encoding parameter may comprise a number of possible parameter choices that the video encode processor 119 can choose between when performing the encoding.

In the preferred embodiment, the encoded video signal is fed back to the processor receiver 107 and the video analysis processor 101 performs another analysis based on the encoded video signal. Thus in step 217, the video encoder 103 determines if the iteration process has finished. If so, the encoded picture is outputted in step 219.

If the iteration has not finished, the method returns to step 201, and steps 201 to 209 are repeated but this time based on the encoded picture rather than the original picture received from the external picture source. Thus, in the second iteration, the processor receiver 107 receives the encoded picture from the video encoder in step 201, the segmentation processor 109 divides the encoded picture into a plurality of encoded picture regions in step 203, the picture characteristic processor 111 determines an encoded picture characteristic for at least one encoded picture region of the plurality of encoded picture regions in step 205, the video encoding selector 113 selects a second video encoding parameter for the encoded picture region in response to the encoded picture characteristic of the encoded picture region in step 207 and feeds the second video encoding parameter to the video encoder in step 209.

In this second iteration, the picture characteristic and thus the video encoding parameter selection may be based on characteristics of the encoded signal and may specifically be determined in response to video encoding characteristics, statistics or errors. This allows for a facilitation of the process in many cases. For example, a texture level may directly be determined from the coefficient values of the DCT coefficients of the encoding of macro-blocks in a given picture region. The iteration thus allows for improved video encoding and allows for video encoding parameters to be fine tuned in order to achieve a desired video encoding performance.

The second video encoding parameter is subsequently fed to the video encoder 103 and the picture is re-encoded using the second video encoding parameter.

The process may be iterated further by feeding the re-encoded video signal to the processor receiver 107 and repeating the described steps. The process may be iterated as many times as is desired. For example, the process may be iterated until a given quality level is achieved or a given computational resource or time has been used.

The proposed concept of iterative encoding is particularly suitable for off-line multi-pass encoding. In this application, an input video signal is encoded in a number of iterations, where the coding statistics obtained after each iteration are used to adjust the coding parameters for the next iteration.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A video encoding apparatus (100) comprising:
a video analysis processor (101) comprising
means (107) for receiving a picture for encoding,
means (109) for dividing the picture into a plurality of picture regions;
means (111) for determining a picture characteristic for at least one picture region of the plurality of picture regions, and
means (113) for selecting a video encoding parameter for the at least one picture region in response to the picture characteristic; and
a video encoder (103) comprising:
means (117) for receiving the picture for encoding,
means (115) for receiving the video encoding parameter from the video analysis processor, and
means (119) for encoding the picture using the video encoding parameter for the at least one picture region.

2. A video encoding apparatus (100) as claimed in claim 1 wherein the means (109) for dividing the picture is operable to determine the plurality of picture regions by segmentation of the picture.

3. A video encoding apparatus (100) as claimed in claim 2 wherein the segmentation of the picture comprises tracking an object between pictures of a video signal.

4. A video encoding apparatus (100) as claimed in claim 1 wherein the means (109) for dividing the picture is operable to divide the plurality of picture regions in response to picture properties not comprised in the picture characteristic.

5. A video encoding apparatus (100) as claimed in claim 1 wherein the means (109) for dividing the picture is operable to determine the at least one picture region as a picture region having picture characteristics resulting in a high sensitivity to video encoding parameters.

6. A video encoding apparatus (100) as claimed in claim 1 wherein the means (109) for dividing the picture is operable to divide the picture into a plurality of segments in response to a segmentation criterion and to determine the at least first picture region by grouping a plurality of segments.

7. A video encoding apparatus (100) as claimed in claim 6 wherein the division into the plurality of segments is in response to a segmentation criterion and the grouping is in response to video encoding characteristics of the plurality of segments.

8. A video encoding apparatus (100) was claimed in claim 1 wherein the picture characteristic comprises a texture characteristic.

9. A video encoding apparatus (100) as claimed in claim 1 further comprising means for coupling the encoded picture from the video encoder to the video analysis processor (101) and the video analysis processor (101) is operable to generate the picture characteristic in response to the encoded picture.

10. A video encoding apparatus (100) as claimed in claim 9 wherein the video encoding apparatus (100) is operable to encode the picture by iteratively selecting a video encoding parameter for the at least one picture and encoding the picture using the video encoding parameter for the at least one picture region.

11. A video encoding apparatus (100) as claimed in claim 1 wherein the video encoding parameter comprises a quantisation parameter.

12. A video encoding apparatus (100) as claimed in claim 1 wherein the video encoding parameter comprises an encoding block type parameter.

13. A video encoding apparatus (100) as claimed in claim 1 wherein the video encoding parameter comprises an inter frame prediction mode parameter.

14. A video encoding apparatus (100) as claimed in claim 1 wherein the video encoding parameter comprises a reference picture selection parameter.

15. A video encoding apparatus (100) as claimed in claim 1 wherein the video encoding parameter comprises a de-blocking filtering parameter.

16. A video encoding apparatus (100) as claimed in claim 1 wherein the video encoder (119) is operable to encode the video signal in accordance with the H.26L standard.

17. A method (200) of video encoding for a video encoding apparatus (100) having a video analysis processor (101) and a video encoder (103) comprising the steps of:
in the video analysis processor (101):
receiving (201) a picture for encoding,
dividing (203) the picture into a plurality of picture regions;
determining (205) a picture characteristic for at least one picture region of the plurality of picture regions;
selecting (207) a video encoding parameter for the picture region in response to the picture characteristic of the picture region, and
feeding (209) the video encoding parameter to the video encoder;
and in the video encoder (103):
receiving (211) the picture for encoding
receiving (213) the video encoding parameter from the video analysis processor, and
encoding (215) the picture using the video encoding parameters for each picture region.

18. A method of video encoding as claimed in claim 17 further comprising the steps of:
in the video analysis processor:
receiving the encoded picture from the video encoder,
dividing the encoded picture into a plurality of encoded picture regions;
determining an encoded picture characteristic for at least one encoded picture region of the plurality of encoded picture regions;
selecting a second video encoding parameter for the encoded picture region in response to the encoded picture characteristic of the encoded picture region, and
feeding the second video encoding parameter to the video encoder;
and in the video encoder:
receiving the second video encoding parameter from the video analysis processor, and
encoding the picture using the second video encoding parameters for each picture region.

19. A computer program enabling the carrying out of a method according to claim 18.

20. A record carrier comprising a computer program as claimed in claim 19.
